(19) United States
(12) Patent Application Publication
(10) Pub. No.: US 2006/0253597 A1
(43) Pub. Date: Nov. 9, 2006

(54) E-mail system

(75) Inventor: Alberto Mujica, Miami, FL (US)

Correspondence Address: Alberto Mujica, 9870 SW 166 Ct, Miami, FL, 33196, US

(73) Assignee: Mujica Technologies Inc.

(21) Appl. No.: 11/346,085

(22) Filed: Feb. 1, 2006

Related U.S. Application Data
(60) Provisional application No. 60/594,781, filed on May 5, 2005.

(51) Int. Cl. G06F 15/16

(52) U.S. Cl. 709/229

(57) ABSTRACT

A system and method for filtering communications between a sender and a recipient based on information stored in a database. The system comprises a client program, a web service program and a web interface for entering information to the database. The method comprises receiving a communication from a sender, extracting unique identification information from the communication that identifies the sender of the communication, extracting a first set of information stored in the database that is associated with the unique identification information, extracting a second set of information that is stored in the database that is associated with, a recipient's preferences about the types of communications the recipient is willing to receive, comparing the first set of information with the second set of information to determine if the communication should be allowed or denied, allowing the communication to reach its intended recipient or denying the delivery of the communication based on the result of the comparison of the first set of information with the second set of information, and billing the sender for each delivery of the communication.

### CLAIM OF PRIORITY

This application claims priority to U.S. provisional patent Ser. No. 60/594,781 filed on May 5, 2005, the entire disclosure of each being incorporated herein.

### BACKGROUND OF THE INVENTION

The rapid increase in the number of users of electronic mail and the low cost of distributing electronic messages via the Internet and other communications networks has made mass marketing via electronic mail (“e-mail”) an attractive advertising medium. Consequently, e-mail is now frequently used as the medium for widespread marketing broadcasts of unsolicited messages to e-mail addresses, commonly known as “spam.” Electronic mass marketers (also called “spammers”) use a variety of techniques for obtaining e-mail address lists. For example, marketers obtain e-mail addresses from postings on various Internet sites such as news group sites, chat rooms, or directory services sites, message board, mailing lists, and web sites by identifying “mailto” address links provided on web pages. Using these and other similar methods, electronic mass marketers may effectively obtain large numbers of mailing addresses, which become targets for their advertisements and other unsolicited messages. The quality of targeted lists, however, tends to degrade rather quickly over time due to the fluid nature of the Internet and the changing interests of Internet users. Consequently, there is an obvious interest by the bulk e-mailers to oversubscribe their mailing lists with any and all e-mail addresses that may be relevant targets for the content of spam message.

Users of Internet services and electronic mail, however, are not eager to have their e-mail boxes filled with unsolicited e-mails. This is an increasing problem for business entities with easily identifiable e-mail addresses such as large corporations (e.g., IBM, Microsoft, General Motors, etc.). Businesses object to junk mail because it utilizes computer resources, internet bandwidth and reduces worker productivity.

Accordingly, there is a need for a system that automatically and efficiently identifies unsolicited e-mails messages and controls the delivery of these messages to users.

### SUMMARY OF THE INVENTION

The present invention recognizes and addresses the foregoing considerations, and others, of prior art construction and methods. Accordingly, it is an object of the present invention to provide an improved e-mail system.

This and other objects are achieved by a method for filtering communications comprising the steps of receiving a communication from a sender, extracting unique identification information from the communication that identifies the sender of the communication, extracting a first set of information stored in a database that is associated with the unique identification information, extracting a second set of information that is stored in the database that is associated with a recipient's preferences about the types of communications the recipient is willing to receive, comparing the first set of information with the second set of information to determine if the communication should be allowed or denied, allowing the communication to reach its intended recipient or denying the delivery of the communication based on the result of the comparison of the first set of information with the second set of information, and billing the sender for each delivery of the communication.

The first set of information may include data regarding previously sent communications, or one or more of the senders name, address and telephone number. The database may be located remote from the sender and the recipient. The method may also include sending a notice to the sender when the communication is denied. The communication may also be denied if the first set of information is not available for the sender. The notice can invites the sender to register with a service so that future communications can be delivered to recipients. The communications may take the form of e-mails, telephone calls, VoIP communications, instant messages, web browsing, etc. The unique identifier may be a server address for the sender.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a block diagram of a prior art e-mail system;

FIG. 2 is a block diagram of prior art computer system suitable for use in an embodiment of the present invention;

FIG. 3 is a diagram of the components of a server computer suitable for use in an embodiment of the present invention;

FIG. 4 is a is a block diagram of an e-mail system for use with an embodiment of the present invention;

FIG. 5 is a screen shot of the MTRM client of an embodiment of the present invention;

FIG. 6 is a screen shot of the MTRM client of an embodiment of the present invention;

FIG. 7 is a screen shot of the MTRM client of an embodiment of the present invention;

FIG. 8 is a screen shot of the MTRM client of an embodiment of the present invention;

FIG. 9 is a screen shot of the MTRM client of an embodiment of the present invention;

FIG. 10 is a screen shot of the MTRM client of an embodiment of the present invention;

FIG. 11 FIG. 9 is a screen shot of the MTRM client of an embodiment of the present invention;

FIG. 12 is a decision diagram of the MTRM Web Service of an embodiment of the present invention;

FIG. 13 is a flow diagram of an embodiment of the present invention;

FIG. 14 is a process flow diagram of an embodiment of the present invention;

FIG. 15 is a screen shot of an e-mail program including a reporter plug-in;

FIG. 15A is an embodiment of the reporter plug-in of FIG. 15;

FIG. 16 is a screen shot of a web interface in accordance with the present invention;

FIG. 17 is a screen shot of the web interface of FIG. 16;

FIG. 18 is a screen shot of the web interface of FIG. 16;

FIG. 19 is a screen shot of the web interface of FIG. 16;

FIG. 20 is a screen shot of the web interface of FIG. 16;

FIG. 21 is a screen shot of the web interface of FIG. 16;

FIG. 22 is a screen shot of the web interface of FIG. 16;

FIG. 23 is a screen shot of the web interface of FIG. 16;

FIG. 24 is a screen shot of the web interface of FIG. 16; and

FIG. 25 is a screen shot of the web interface of FIG. 16.

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof For instance, features illustrated or described as part of one embodiment may be used on another embodiment to yield a still further embodiment. Thus, it is intended that the present invention covers such modifications and variations as come within the scope of the appended claims and their equivalents.

The detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures reside in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc. which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

A system in accordance with the present invention comprises a plurality of computer terminals and servers. Each type of computer may be generally similar to every other type of computer including a central processing unit, display device, and operator input device. Moreover, it will be appreciated that each type of computer may also perform operations described herein as being performed by every other type of computer. The distributed system may comprise any one of a number of types of networks over which client computers and server computers communicate, including local area networks (LANs), wide area networks (WANs), the Internet and any other networks that distribute processing and share data among a plurality of nodes. The on-line services typically provide functionality such as electronic mail (email, POP, IMAP, RPC, SMTP), file transfer protocol (FTP), and World Wide Web (WWW, HTTP, HTTPS) access.

The WWW is a graphical subnetwork of the Internet. With common “web browser” software such as Mosaic, Internet explorer, Mozilla or Netscape Navigator, users may easily access Internet information and services on the WWW. The browser handles the function of locating and targeting information on the Internet and displaying information provided by a server. The WWW utilizes the technology called “hypertext” to organize, search, and present information on the Internet. Using the browser, a user can select a word (“hypertext word”) from a viewed document, and be linked to another document featuring information related to that word. These links are within the Web server domain and result in a progressively deeper search or base of choices.

In the business arena, a service provider can, with an Internet address and a hypertext editor, develop a hypertext document called a “web page,” which a user may explore visiting the provider's Web server. The web page furnishes information about the service(s) offered by the provider through use of graphic images, sound, hyperlink choices, etc. With that information, the user is guided through the web page to select the service and desired service features.

### Prior Art E-Mail Systems

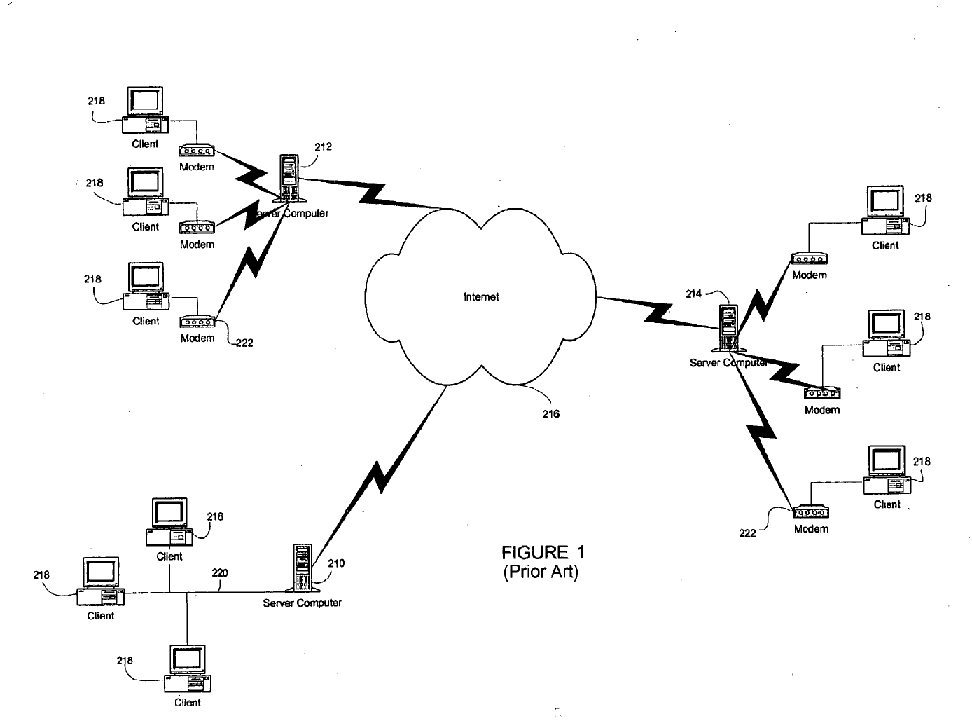

FIG. 1 is a high level diagram of prior art computer networks for communicating e-mail. Illustrated are three e-mail servers 210, 212 and 214 that are operable to communicate with one another over a network 216, which may be for example, the Internet. E-mail servers 210, 212 and 214 communicate e-mails, and may be operated by an ISP, a corporate computer department, or any other organization with a mail server connected to any network, like the Internet 216. Each of the mail servers is accessible by client stations 218, which are used to send and receive e-mails and browse web pages. Client stations 218 may connect to mail servers via a local area network (LAN) 220, as shown in relation to server 210, or using a remote connection device 222, for example a modem, as is shown in connection with servers 212 and 214.

Client stations 218 comprise e-mail client software for communicating with e-mail servers 210, 212, and 214. While client stations 218 are depicted as desk top computers, any type of computing machine such as, for example, a PDA, a cell phone, or a lap top computer are suitable for carrying out the functionality of an e-mail client. In the system of FIG. 1, e-mails are drafted at client stations 218 and forwarded to one of e-mail servers 210, 212, and 214, which communicate the e-mails over Internet 216 using SMTP protocol and are ultimately delivered at the other of e-mail servers 210, 212, and 214. It should be understood that FIG. 1 shows only three e-mail servers for simplicity and ease of explanation, but there may be an unlimited number of e-mail servers connected to internet 216.

E-mail servers 210, 212 and 214 comprise e-mail server software, such as simple mail transfer protocol (SMTP) and post office protocol (POP) software for receiving and routing e-mail. Those of ordinary skill in the art will recognize that while servers 210, 212 and 214 are depicted using a single machine in FIG. 1, the servers may comprise a plurality of computing machines to accomplish the same functionality.

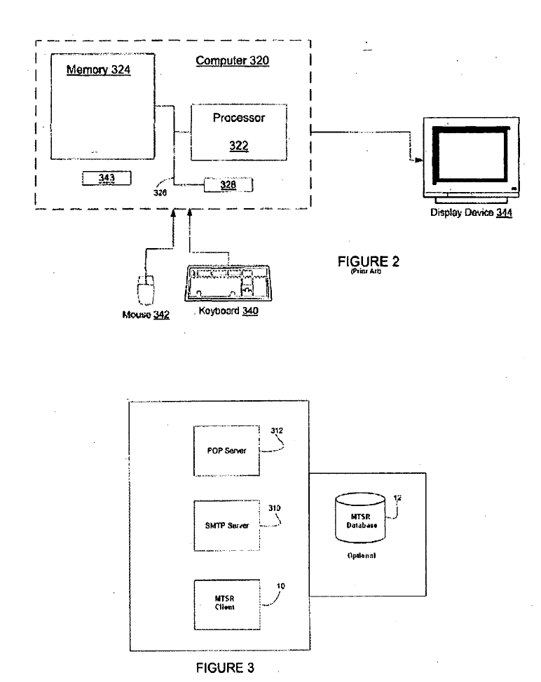

E-mail servers 210, 212 and 214 as well as client stations 218 are generic computing systems. FIG. 2 is a block diagram of a generic computing system suitable for use in a system in accordance with the present invention. As shown, computing device 320 includes processing unit 322, system memory 324, and system bus 326 that couples the various system components including the system memory to the processing unit. The system memory 324 may include read-only memory (ROM), random access memory (RAM) and a hard-drive 328, which provides storage for computer readable instructions, data structures, program modules and other data. A user may enter commands and information into computer 320 through input devices such as a keyboard 340 and mouse 342. A monitor 344 or other type of display device is also connected to the system for output. Communications device 343, which may be a modem, provides for communications over network 216. Processor 322 can be programmed with instructions to interact with other computing systems so as to perform the algorithms of the present invention, as described below. The instructions may be stored in memory 324 and/or hard drive 328. Processor 322 may be loaded with any one of several computer operating systems such as Windows NT, Windows 2000, Linux, etc.

### Improved E-Mail System

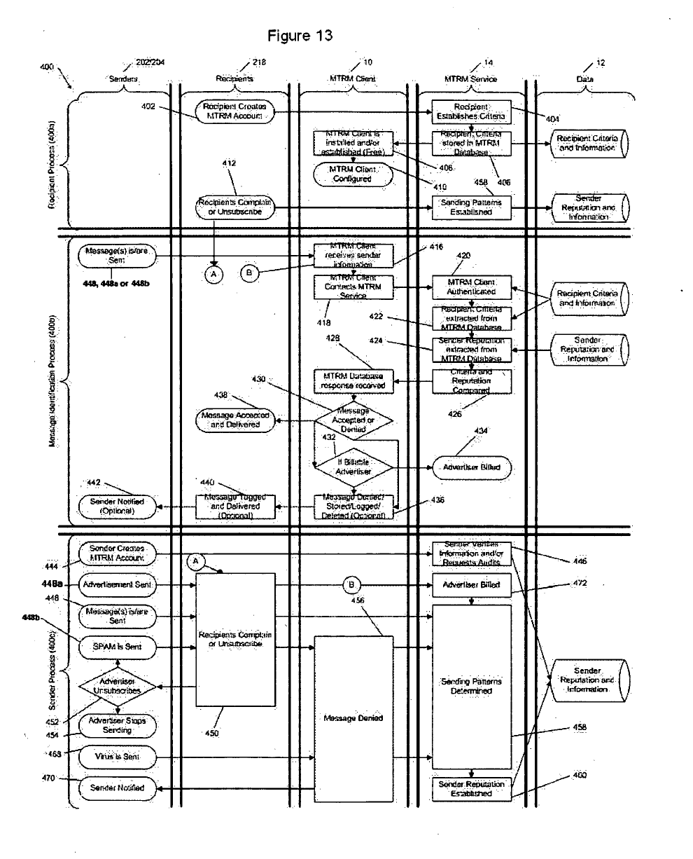

FIG. 3 is a diagram of the software components of e-mail servers 210, 212 and 214 in accordance with an embodiment of the present invention. As shown, servers 210, 212 and 214 comprise SMTP server software 310, POP server software 312, and MTRM Client software 10. Optionally, the server may also contain an MTRM database 12, or the database may be located remotely from e-mail servers 210, 212 and 214. One of ordinary skill in the art should understand the operating methods of SMTP server software 310 and POP server software 312 in routing outgoing and incoming e-mails. MTRM Client software 10 and MTRM database 12 operate as described below in connection with FIG. 13 to regulate e-mail flowing between servers.

Unsolicited commercial e-mail, commonly referred to as spam, may be generated through bulk e-mail deliveries from a computer system, such as one of client stations 218 or servers 214, to Internet 216. Conventionally, spam routes through Internet 216 as ordinary e-mail, spooled by an e-mail server ultimately for delivery to identified destination client stations 218. In some cases, the return e-mail address is intentionally obscured to avoid self-identification. The bulk e-mailer client station 218 can easily control the removal of the From: line of the e-mail messages, substitute a non-existent return e-mail address, or substitute a valid e-mail address corresponding to an unrelated client station 218. Thus, while the e-mail recipient can attempt to identify and complain to the postmaster of an ISP providing service to the bulk e-mailer, it is difficult to properly identify the relevant ISP. Further, the e-mail recipient has little or no authoritative or commercial position to have an ISP limit the activities of a bulk e-mailer.

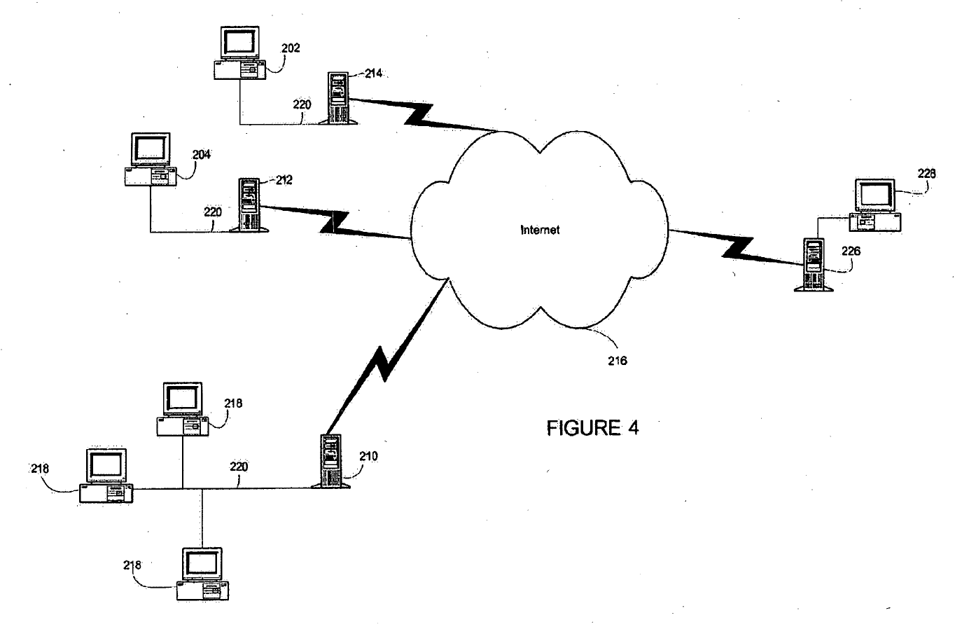

Referring to FIG. 4, the present invention operates in the environment of prior art e-mail communication networks shown in FIG. 1. In particular, an advertising client 202 connects to internet 216 through mail server 214, spammer 204 connects to internet 216 through mail server 212, clients 218 connect to internet 116 through mail server 210 and a server 226 connects central computer 228 to internet 216. As before, the illustration has been limited to three servers for ease of explanation, but it should be understood that multiple servers and clients are present.

The system of the present invention includes MTRM client software 10, MTRM database 12, MTRM web service 14, MTRM web interface 15, and MTRM Reporter 17 (FIG. 15). MTRM client software 10 resides on an ISP, corporate or other mail server 210, MTRM web interface 15, MTRM database 12 and MTRM web service 14 reside on central computer 226 or at another centrally prearranged location and MTRM Reporter 17 resides on the computer of e-mail client 218.

MTRM Client Software

MTRM client software 10 allows ISPs, corporations and/or individuals to determine how email is received, authentication methods, what destination SMTP servers to send email to and other local application configuration options. MTRM client software 10 communicates over internet 116 with database 12 through MTRM web service 14 to determine which e-mail communications from advertising and non-advertising clients 202 to accepted and forward to ISP, corporate or individual clients 218 and which e-mail from spammer 204 to deny and block.

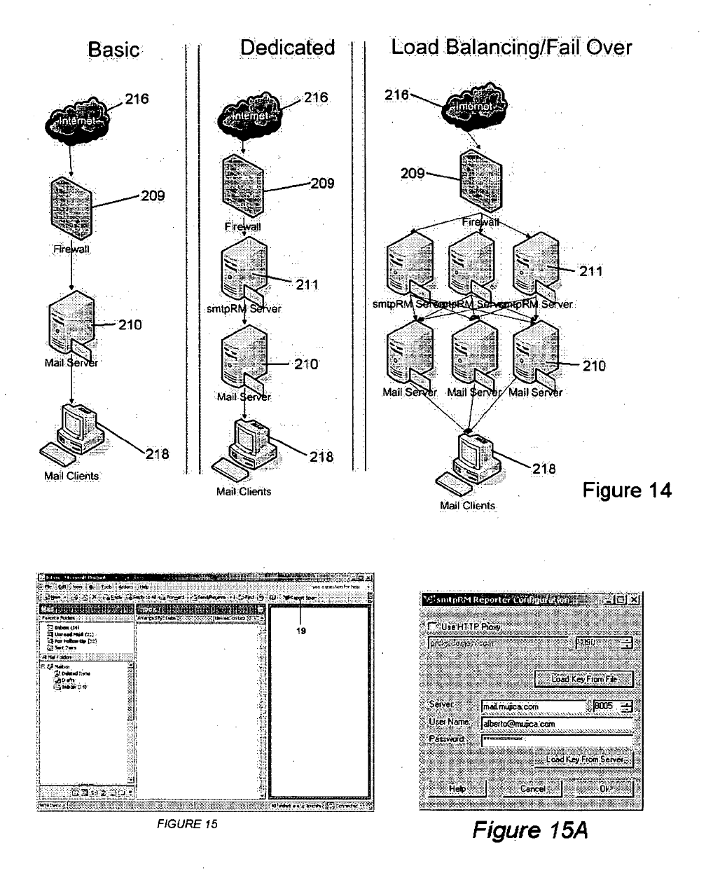

Referring to FIG. 14, the MTRM client software may be setup in the user's system in one of three configurations: shared, dedicated, and/or cluster. In the shared configuration, the user installs MTRM client software 10 on the same machine that the destination SMTP server is installed. This is practical in low volume, non-redundant environments where scalability, performance, and redundancy are not required and/or necessary. In particular, internet 216 connects to mail server 210 through a firewall 209. The firewall blocks incoming port 2525, and the SMTP mail service is installed on mail server 210 and is listening on port 2525. MTRM client software 10 is installed on mail server 210 and is listening on port 25, which is not blocked by firewall 209, and forwards SMTP requests to IP address 127.0.0.1:2525.

In the dedicated configuration, the user installs MTRM client software 10 on a separate machine from the destination SMTP server machine which allows for better scalability, performance, and redundancy by distributing the load between servers. Specifically, mail server 210 connects to internet 216 through firewall 209 and MTRM server 211. MTRM client software 10 is loaded on an MTRM server 211 and listens on port 25 for incoming messages and forwards SMTP requests to mail server 210. The mail service is installed on mail server 210 and listens for requests on port 2525 for incoming requests. As mail is received, it is forwarded to mail clients 218.

Finally, in a cluster configuration, the user installs MTRM client software 10 on several machines and has the ability to deliver email to many destination SMTP machines. It can do so by using load balancing, which works by sending messages in a “round robin” fashion, taking turns to send the messages to the different machines or in a “fail over” fashion sending messages always to a specified machine and then sending it to the other machines only when this specified machine becomes unavailable. This configuration provides users with the most flexibility and virtually limitless scalability, performance, and redundancy. Referring to the figure, the system is similarly organized as in the dedicated configuration, except there are multiple MTRM servers and multiple mail servers. Incoming messages are received by the MTRM servers 211 and forwarded to a mail server based on the message load at the mail servers 210. The mail messages are forwarded to mail clients 218.

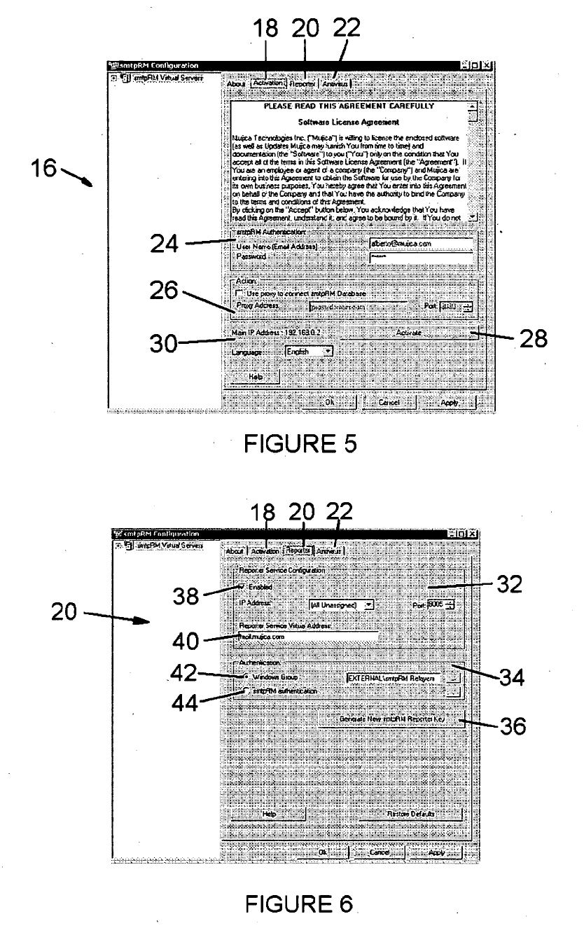

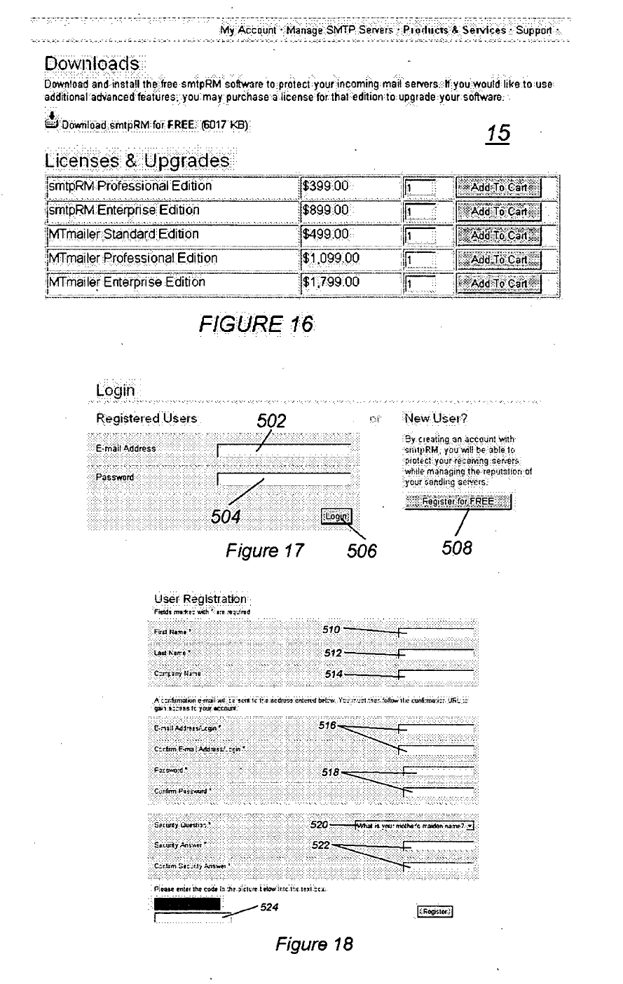

Referring to FIG. 16, MTRM client software 10 is downloaded from a web interface (FIG. 16) onto the ISP, corporate or individual mail server 210 in computer memory 323 (FIG. 3) and installed onto the server. Once loaded, configuration menus 16, FIGS. 5-11, are accessible to configure the operation of MTRM client software 10. Configuration menu 16 includes an activation menu 18, a reporter menu 20 and a antivirus menu 22.

In particular and referring to FIG. 5, activation menu 18 provides an authentication section 24, an action section 26 and an activation button 28. A user inputs its MTRM web service username and password in authentication section 24. The MTRM web service username and password is the same username and password used to establish its account with the service. Action section 26 allows the user to select to connect to web service 14 via a proxy if e-mail server 210 is installed behind a proxy server and needs the proxy server to access internet 216. The proxy address is the IP address or host name of the proxy service in the network. A port entry box is available to enter the port number on which the proxy server is listening on for requests for web content requests. A main IP address 30 indicates the IP address that is recognized by MTRM client software 10 as the main IP address on the server. IP address 30 is the address that must be used as the client IP address on web service 14, as discussed further herein.

Activation button 28, once depressed, gathers all information and activates MTRM client software 10 and determines licensing and edition information. An MTRM client software reporter ID is automatically generated and the edition of the software is automatically determined, which prevents a user from using an unpaid or unregistered copy of MTRM client software 10. The reporter ID also allows web service 14 to track complaints logged by mail server administrators and clients to determine if the complaint system is being abused. Complaints lodged by e-mail administrators can adversely affect an advertiser's reputation and in turn their ability to have their advertisements delivered to clients so identifying the source of complaints is important to ensure the integrity of the system.

Referring to FIG. 6, reporter menu 20 provides the user the ability to set the environment in which the MTRM client software reporter will behave. The report menu contains a reporter configuration section 32, an authentication section 34 and a generate new reporter key button 36. Reporter configuration section 32 has an enable check box 38 that allows the reporter service to begin running automatically whenever MTRM client software 10 is running. Reporter service configuration section 32 also includes an IP address menu and port menu that allows the user to set the IP address and port that the reporter service will listen on for requests. A reporter service virtual address menu 40 is provided in the event that the reporter service is being load balanced or behind a specific firewall and the IP address or host name with which the client will be accessing web service 14 is different than the literal IP address listed in the IP address field.

Authentication section 34 includes radio buttons 42 and 44 respectively for selecting a windows group and MTRM authentication. That is, if windows group button 42 is selected, the user can select a group from an active directory or local machine to authenticate users that want to use the reporter service. Authentication button 44 allows the user to select a new group of a generic username and password for all users.

MTRM Reporter 17 (FIG. 15) is an add-on plug-in component for Outlook or other mail programs located on the computer of e-mail client 218. MTRM reporter 17 facilitates reporting of spam mail or e-mail abuse from end users by allowing the end user to click a button 19 located in their e-mail program that causes a message to be sent to MTRM web service 14. Referring to FIG. 15A, a set-up screen is shown for the MTRM reporter plug-in that allows the user to link the reporter to the client software by entering the mail server address, a user name and a password and/or by loading a key from a local file or from the server.

Every installation of MTRM client software 10 contains a unique identifier that helps web service 14 determine what settings to use when allowing or denying a specific message. The MTRM reporter plug-in provides an additional id number that relates a specific e-mail client 218 to MTRM client software 10. Thus, each message sent to web service 14 contains a unique identification that associates the message with the MTRM client software 10 and the sender. This link is necessary to maintain the integrity of the system and identify all complaints with a specific MTRM software client and sender since anonymous complaints are not allowed and would compromise the integrity of the system.

Generate new reporter key button 36 allows the user to generate a new reporter key from the remote site. This can be performed whenever the user feels the original key has been compromised or on a schedule to ensure a secure connection.

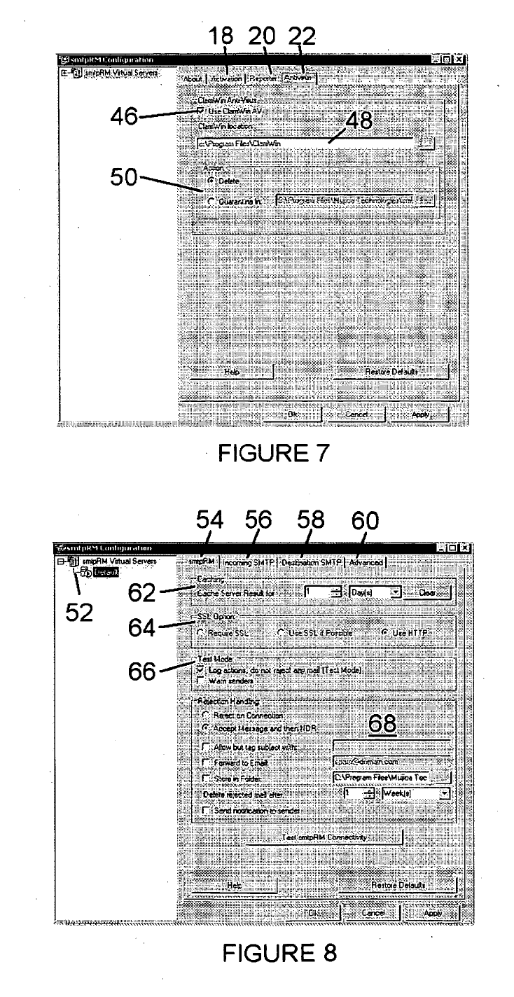

Referring to FIG. 7, antivirus menu 22 has a radio button 46 that allows MTRM client software 10 to link to the user's antivirus software. An address window 48 allows the user to enter the address of the antivirus software so that incoming e-mail messages may be scanned by the antivirus software. An action section 50 allows the user to select whether to delete infected messages or to quarantine such messages until they can be addressed by the user.

Referring to FIG. 8, configuration menu 16 can be further expanded to disclose a default set 52 of menus. The default menus contain an smtpRM menu 54, an incoming SMTP menu 56, a destination SMTP menu 58 and an advanced menu 60. smtpRM menu 54 allows the user to configure all settings specific to the operation of MTRM client software 10. For example, smtpRM menu 54 includes a caching section 62, a SSL option section 64, a test mode section 66 and a rejection handling section 68.

Caching section 62 allows the user to set caching options for the results from MTRM client software 10. Caching can be set from as little as one minute and longer. The longer the results are cached, the more efficient and better performing client software 10 will perform, by minimizing traffic through the network. This happens because information related to a sender is stored in memory and new messages are compared to the data stored in memory instead of checking the sender information with MTRM database 12 through MTRM web service 14. Thus, the longer the cache, the less accurate the results may be. As a result, there must be a balance between the length of the cache and the performance and accuracy of MTRM client software 10.

SSL option section 64 allows the user to either require that an SSL connection be used for communication between MTRM client software 10 and MTRM database 12 through web service 14, use an SSL connection if possible or to use an HTTP type connection. Test mode 66 allows the user to install and run MTRM client software 10 without performing any permanent actions on messages that it identifies as spam. Use of the test mode will, however, perform all other actions, such as sending Non Delivery Reports (NDRs) if specified, forward suspect messages to a specified address, etc. The warn senders check box 68 allows the user to send an NDR warning to senders indicating that their message has been rejected by MTRM client software 10 and inviting them to register and establish an account and reputation so that their messages may be routed by MTRM client software 10 in future delivery attempts.

Rejection handling section 70 allows the user to configure how the MTRM client software 10 will behave when a message is to be rejected because it's considered spam. Depending on the setting, MTRM client software 10 can always forward a message to it's destination, but tag the subject with a predetermined message indicating that the message is spam, forward the e-mail to a preset address, store the e-mail message in a folder for administrator review, for a predetermined period of time at which time the stored messages are deleted. The user may also decide to send NDRs to the senders of rejected messages, regardless of the other actions taken on the suspect e-mail messages.

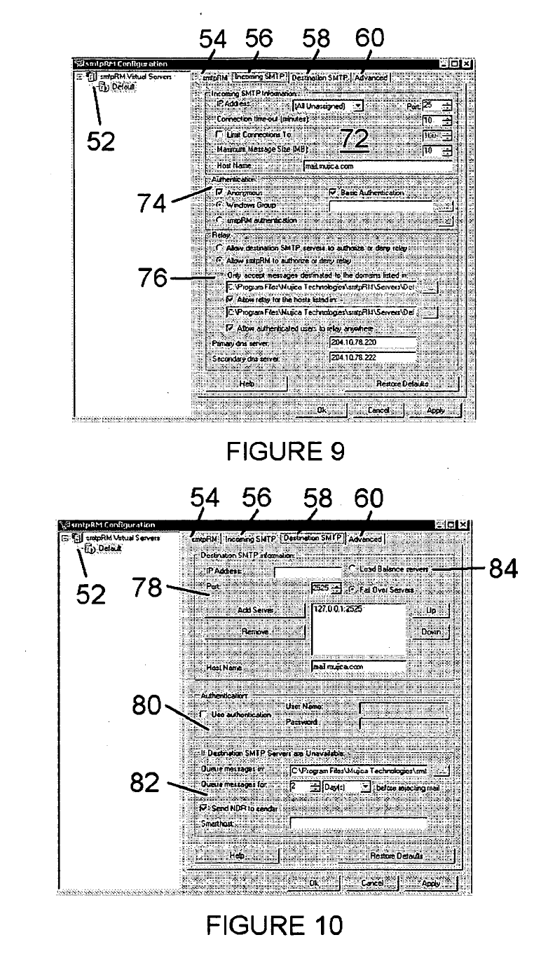

Referring to FIG. 9, incoming message menu 56 allows the user to configure settings related to the incoming SMTP service, which is where all messages to be evaluated are received. Incoming SMTP menu 56 has three major sections: an incoming SMTP information section 72, an authentication section 74 and a relay section 76. The user may set the local IP address of the server on which MTRM client software 10 will listen to incoming SMTP requests. If “all unassigned” is specified in the drop down menu, MTRM client software 10 will listen on all IP addresses not specified in another virtual client. Otherwise, it will listen on the IP address listed. The user can also input which port the software should listen on, which by default and under normal internet facing circumstances should be 25. The user may also set the time MTRM software 10 will stay connected to an inactive incoming SMTP connection. A selection box is provided to set the number of concurrent incoming SMTP connections. The user may also set the maximum incoming message size. Finally, a host DNS name may be input.

Authentication section 74 allows the user to select the type of authentication for incoming connection. The user may select an anonymous authentication, which allows all incoming SMTP connections to occur without being challenged for a user name and/or password, which should be used under normal internet facing circumstances. The basic authentication box allows the user to require a user name and password for other users to use the SMTP service. If the radio button is selected for windows group, the user can select a group from the active directory or local machine to authenticate users wishing to use the SMTP service. Finally, if the smtpRM radio button is selected, the user can select a new group or a generic username and password for users.

Relay section 76 allows the user to select whether the destination SMTP servers authorize or deny the relay of messages. An open relay host allows “anyone” to send e-mails “through” the SMTP server to anyone else on the internet. Open relay is not something specific to MTRM client software 10 and is a part of SMTP. MTRM client software 10 prevents recipients from receiving emails with open relay configurations by randomly testing all servers which have registered with MTRM web service 14 for open relay configurations. A radio button is also provided to allow the user to set MTRM client software 10 to allow or deny message relay before forwarding the message to the destination SMTP servers based on the following options:
Only accept messages destined to the domains listed in the listed text file. This option allows the host listed in the specified text box to relay openly through MTRM client software 10;
Allow relay for the hosts listed in: this option allows the hosts listed in the specified text box to relay openly through MTRM client software 10. IP address 127.0.0.1 is listed by default; and
Allow authenticated users to relay anywhere: this option allows any user which authenticates to relay to any host.

The primary DNS server input provides the IP address used to deliver mail to relayed hosts and NDRs. The secondary DNS server input provides the IP address used to deliver mail to relayed hosts and NDRs in the event the primary DNS server is unavailable.

Referring to FIG. 10, destination SMTP menu 58 allows the user to configure the ultimate destination server to which mail will be delivered. In one embodiment, server 210 would be the destination server. The destination server is where the client mailboxes exist. Thus, the destination SMTP server may be an Exchange, Windows, Imail, Lotus Notes, or any other mail server that can receive email or SMTP messages.

Destination SMTP information section 78 allows the user to input the IP address of a destination SMTP server to be added to the list of destination SMTP hosts. In the shared configuration only 127.0.0.1 may be entered, in dedicated configurations, a single IP address may be entered, but does not necessarily need to be 127.0.0.1. In the cluster configuration, multiple IP addresses may be entered. A box is provided for the user to input the port number of a destination SMTP server to be added to the list of destination SMTP hosts. An add server button-adds the information in the IP address and port text boxes to the list of destination SMTP hosts. A remove button, when a host is selected from the list, will remove that host from the list. A load balance radio button 84 when selected “round robins” mail to the destination SMTP hosts in the list.

Referring to FIG. 14, in the cluster configuration, the ISP or corporation is able to deliver its mail to several different SMTP servers configured to handle mail as a cluster or load balancing farm. This allows for redundancy, scalability and performance. A fail over radio button, when selected, delivers all mail to the first server in the list of destination SMTP hosts until it finds that it is unavailable at which point it moves down the list until it finds another server in the list to which it can deliver mail.

An authentication section 80, when selected, requires clients to enter a user name and password in the adjacent fields to provide authentication for the destination SMTP host. The username and password are required to authenticate into the destination SMTP hosts.

If the destination SMTP servers are unavailable section 82 allows the user to specify a folder in which to queue mail in the event none of the destination SMTP hosts are available. This section also allows the user to specify how long the queue will hold the messages before rejecting the messages in the circumstances mentioned above. A button is provided for the user to select whether to send an NDR through a separate SMTP server dedicated to sending the NDRs. Such a setup is useful if NDR traffic becomes an issue for the current SMTP server.

Referring to FIG. 11, the advanced menu 60 is shown having an allowed and disallowed hosts section 86, an if the MTRM web service 14 is unavailable section 88 and a logging section 90. The advanced menu allows the user to configure all settings that are considered advanced and that rarely need to change from the defaults. The allowed or disallowed hosts section 86 allows the user to list hosts that should not be looked up by MTRM web service 14. Thus, hosts listed will always be allowed through to the destination SMTP hosts. The user can also list hosts that should not be looked up by MTRM web service 14 since these hosts will never be allowed through to the destination SMTP hosts.

If the MTRM web service is unavailable section 88 provides an input that determines how often the MTRM client software 19 attempts to reconnect to the MTRM web service in the event the web service is unavailable because of network issues between the MTRM client and the MTRM web service. Several radio buttons are available for the user to select for handling incoming messages if the MTRM web service is unavailable. These radio buttons include a “use rejection handling settings for all messages” button, which use settings in rejection handling section 68 to react to all messages it receives while the MTRM web service is unavailable. “An allow all messages through” button when selected allows all messages received while MTRM web service 14 is unavailable as if they have been accepted and will be delivered to the destination SMTP servers normally. “A forward to email” button, when selected, causes all messages received while MTRM web service 14 is unavailable to be forwarded to the specified e-mail address. Finally, the “queue messages in” radio button, when selected, queues all messages in the specified folder until the MTRM web service is available or the time specified in the time option expires. After the time expires, the user may select how the messages are handled, for example the messages can become subject to the rejection handling settings in section 68, all messages may be allowed through, or the messages can be forwarded to a specified e-mail.

A logging section 90 allows the user to specify how and where transactions are logged. When the “log application events” button is checked, all application events will be logged. When the “LogRejections” box is checked, all rejections are logged in the specified folder. Finally, when the “log incoming SMTP using W3 extended log file format” box is checked, all SMTP operations are logged in the familiar W3 extended log file format.

MTRM Database

The MTRM database may be a flat file type database or a relational type database. Relational type databases may include MySQL, Microsoft SQL Server and Oracle databases. The MTRM database contains status information about advertisers, senders and recipients who register and open an account.

Sender status information includes information that describes the sender or the sender's message sending patterns. Sender status information may include the sending server's IP address, the server administrator's (commonly known as the postmaster) e-mail address, telephone number, postal address, date the last time a virus was sent from the server, length of time in it's current status, and other criteria as determined necessary to accomplish the goal of the present invention.

MTRM database 12 also contains information on the recipient's message distribution system. Such information includes a known and confirmed server administrator's contact information, information about what the user requires from a sender in order to accept the messages from that sender, for example, allow senders to deliver messages to this recipient if the recipient has confirmed his or her email address, telephone number and postal address and has been in good standing for more than 90 days etc. In addition to the sender's and recipient's information, the MTRM database also includes information necessary to route and accept e-mail messages. MTRM database 12 is accessible via MTRM web service 14 via an internet protocol, such as HTTP(s) but any other protocol or form of communication could be used for other embodiments of this invention without departing from its spirit and scope.

Also contained in MTRM database 12 is the sending patterns of the senders. As messages are received by recipients, web service 14 evaluates the messages through an automated system and determines if the message is marketing material, spam or non-marketing material and then, based on the average kind of message sent by the sender, the system determines if is the sender is sending marketing material or not. Based on the message type, web service 14 marks the messages as such in MTRM database 12.

In one embodiment, the following information is stored in MTRM database 12 to allow the system to manage the delivery of e-mail:
Senders: IP address, if IP address is open relay or not (which is tested for once every 30 days randomly), if the sender is a marketer or not, if the sender is certified or not and the reverse DNS information for the IP address.
All Senders (advertising or not) and Recipients: Name, email, telephone number, if telephone number is confirmed, if confirmed, when the telephone number was confirmed, postal address, if postal address is confirmed, if confirmed, when it was confirmed, if user is enabled or not, and a security question and answer to verify the user in case the user forgets their password.
   Other collected information may include credit score, duns number, telephone routing information, telephone number, etc. when the system is used with other forms of communications like VoIP, Spyware, web, telephone systems or other communications systems.

MTRM Web Service

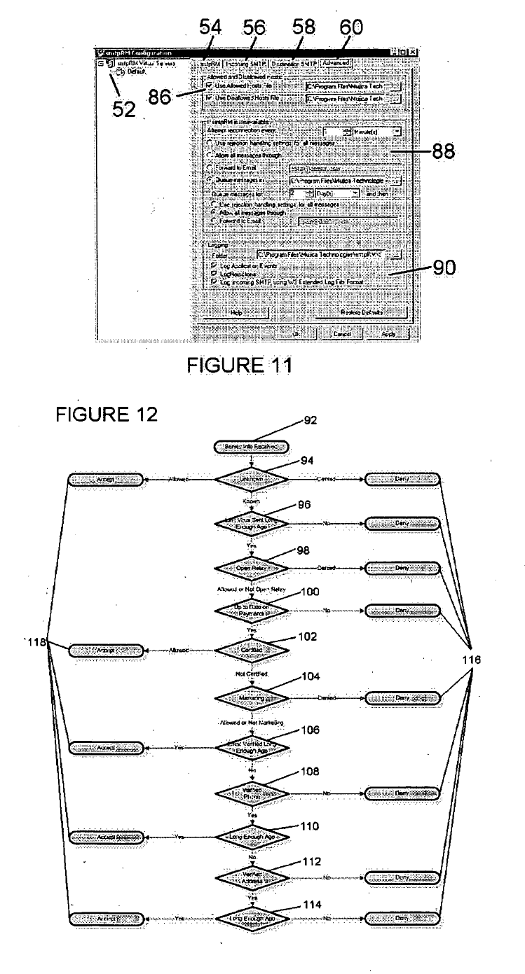

MTRM web service 14 is used to interact with MTRM database 12 and MTRM client software 10 to determine whether a received message should be delivered or denied. Acceptance of a message is determined by comparing information from the sender's e-mail message regarding the sender to information stored in MTRM database 12 and the recipient's settings stored in MTRM database 12 that were set by the recipient through MTRM web interface 15. Referring to FIG. 12, a decision diagram is shown depicting the functionality of MTRM web service 14.

At step 92, sender information is stripped from the received e-mail message and sent by MTRM client software 10 to MTRM web service 14. At step 94, the data is checked to determine if the sender is known or unknown. A known sender is a registered sender who has established an account that includes sender specific identification information and developed a reputation, as explained in further detail below.

If the sender is unknown, MTRM web service 14 directs MTRM client software 10 to accept 118 or deny 116 the message based on information set up by the recipient in the database with respect to unknown senders. For example, the recipient may allow unknown sender e-mails to be delivered to e-mail clients 218 and a warning message may be sent to the sender indicating that they are an unregistered sender and all future e-mails will be blocked unless they register with MTRM web service 14. On the other hand, messages from unknown senders may be blocked outright and a NDR may be sent to the sender.

If the recipient is known, at step 96, MTRM web service 14 checks to see when the last virus was sent in a message sent by the sender. Depending on the length of time from the last time a virus was sent by the sender and the recipient's preference about allowing messages from senders that have sent a virus in a specified period of time, MTRM web service 14 directs the client software to further process the message or it denies the message at step 116.

If the message is further processed, web service 14 checks to see if the sender is sending the message from an open relay server at step 98 and the message is either denied 116 or allowed. If the message is allowed, the sender's information is checked at step 100 to determine if the sender is up to date on its payments for the delivery of previous messages. The present invention contemplates charging a fee to marketers and advertisers whose e-mail messages are delivered to mail clients 218. The charge may be a flat rate charge for delivery to any number of mail clients 218 or it may be a charge based on each recipient mail client 218 or not be charged for at all, if the sender is not a marketing material sender. In either case, if the sender is delinquent in its payment for prior e-mail deliveries, then future messages sent are denied at 116 until the sender's account is brought current.

If the sender is current in its payments, the message is allowed and passed to step 102, where the sender's information is checked to determine if the sender is a certified sender. Certain information may be used to establish whether a sender is certified. The information necessary to certify a sender may be the same for advertisers and non-advertisers or it may be different. The following is a non-exhaustive list of some of the information that may be used to certify a sender and develop a sender's reputation.

A. Advertisers
(i) Server:
   Should have a server with a static IP address.
   IP Address ownership must be verified.
   Should not be an open relay.
   Should have anti-virus software scanning inbound as well as outbound email.
   Anti-virus software should be updated periodically for virus definitions, exploits, and/or vulnerabilities.
   Operating system software should be updated periodically for exploits and/or vulnerabilities.
(ii) Organization:
   No outstanding “Bad debt” should be found for the organization.
   The organization's email address, phone number and postal address should be verified.
   The non-refundable account registration fee should be paid.
   A deposit should be required for all organizations that have less than 3 years in operation because these types of organizations may pose a risk of spam.
   A recertification fee will be required once per year.
(iii) Advertising Procedures:
   Email advertising campaigns should not generate more than 1 complaint for every 100,000 emails sent. The number of complaints per 100,000 e-mails may change depending on the sender's status.
   All complaints will be charged at a predetermined support incident rate, because these will need to be resolved with the sender and the recipient, but complaints beyond this predetermined threshold should trigger an investigation to decertify the sender, if certified, for excessive complaints which are a key indicator of spam activity
   Email recipient lists should not have been bought, rented or otherwise acquired by means other than the recipient's desire to receive marketing information from said organization.
   Consent from the recipients should be of the “double opt-in” format, even if previous business relationship exists. In other words, the recipient must request the information and a confirmation must be sent to the recipient's email, and unless the recipient confirms his desire to receive said information, the advertiser should not add him or her to the list.
   Email lists should not be rented, sold or otherwise be given to other third parties.
   The content of the advertisements need to be targeted to the correct audience and proof of this should be presented by the advertiser. This only applies if the content is somehow controlled. For example, pornographic advertisements can only be sent to email address owners which have proven they are over 18 years of age by way of a credit card and/or government issued identification.
   The subject line of the email should be relevant to, and reflective of the content of the message.
   All header and other email information should not be forged.
   The organization's name, contact email, postal address and phone number should be provided and visible in the email.
   Unsubscriptions should be honored when requested by a recipient.

B. Non-Advertisers
(i) Server:
   Must have a server with a static IP address.
   IP Address ownership should be verified.
   Should not be an open relay.
   Should have anti-virus software scanning inbound as well as outbound email.
   Anti-virus software should be updated periodically (for example at least once per week) for virus definitions, exploits and/or vulnerabilities.
   Operating system software should be updated periodically (for example at least once per week) for exploits and/or vulnerabilities.
(ii) Organization:
   No outstanding “Bad debt” should be found for the organization.
   The organization's email address, phone number and postal address should be verified.
   The organization should pay a non-refundable registration fee for certification.
   A deposit should be required for all organizations that have less than 3 years in operation or otherwise because these types of organizations pose a risk of spam.
   Recertification should occur once per year.

If the sender is a certified sender, then the message is allowed at step 118. If, on the other hand, the sender is not certified, the sender's information is checked at step 104 to determine if the sender is an advertiser or non-advertiser, i.e. if the message is a marketing message, a message sent in the ordinary course of business or personal communication (i.e., jokes and pictures). If the sender is an unregistered advertiser that has not been previously approved for delivery by a user, the message is denied at step 116 and an NDR is sent with a link for the sender to register with web service 14. Otherwise, MTRM web service 14 performs several comparison operations to determine if the allowed uncertified non-advertising message meets minimum criteria before being allowed for delivery to e-mail clients 218.

A user may set up parameters to allow non-certified sender e-mails to be delivered to e-mail clients 218. Some of these parameters may include that one or more of the sender's e-mail address, telephone number, business address, etc. have been verified within a set time frame to ensure that the sending server is not being used to send spam e-mail messages. One of the criteria that a user can set through the web interface is if they want to allow messages from senders that have verified their email for at least some number of months. For example, if the recipient has requested all senders that send to him to have registered and verified their email address for at least 6 months, then at step 106, if the sender has verified his for at least the last 6 months then the message is allowed. If, however, the sender verified his e-mail 2 months ago, then the message does not go through and MTRM web service 14 next checks to see if the sender's phone number has been verified at step 108. If the sender's phone number has never been verified, then the message is denied at 116 and an NDR may be sent to the sender. The sender's phone number is then checked at 110 to determine if the sender's phone number has been verified over some specified period of time set by the user. If it meets the preset criteria, then the message is allowed to proceed to the recipient at step 118. If, on the other hand, the phone number has been verified but not according to the parameters set by the user, then the sender's address is verified at step 112. If the sender's address has not been verified, the message is denied at step 116. In the alternative, if the sender's address has been verified, then web service 14 checks to see if it has been verified in accordance with the parameter set by the user at step 114. As a result, if the senders address has been verified in accordance with the users preset parameters, then the message is allowed to be delivered at 118, otherwise the message is denied at 116 and an NDR may be sent to the sender asking them to register and verify their information.

MTRM Web Interface

MTRM web interface 15 (FIGS. 16-25) allows ISPs, corporations and/or individuals to register criteria for accepting or rejecting e-mail based on a set of criteria including, but not limited to, the time a mail server owner has had his or her email, telephone and postal address confirmed and other sending patterns as discussed in more detail above. All users of the MTRM service register through web interface 15 to set up an account, input general information about their servers, and establish a reputation on the system based on information about the user. The user's information and reputation are used to route or block e-mail messages based on parameters set by mail administrators that are stored in the MTRM database 12. Thus, advertising client 202 and the administrator for e-mail server 210 may register with central computer 226 through web interface 15, as discussed in further detail below.

Referring to FIG. 17, a user may login to the web interface if they are already a registered user by entering a e-mail address at 502 and a password at 504. Once the information is entered, a login button 506 is pressed. If they are not a registered user, button 508 is pressed to enter a registration screen.

FIG. 18 illustrates a registration screen with entry boxes for entering the user's first name (510), last name (512) and company name (514). The user can also enter and confirm his e-mail address 516 and a password at 518. A security questions can be chosen from a drop down menu 520 and an answer to the questions can be input at 522. Finally, a code must be entered at 524 to ensure that the registration is not fraudulent. Box 524 prevents users from writing programs to automated the registration processes and fraudulently register nonexistent users. Thus, the code at 524 changes each time the registration menu is open.

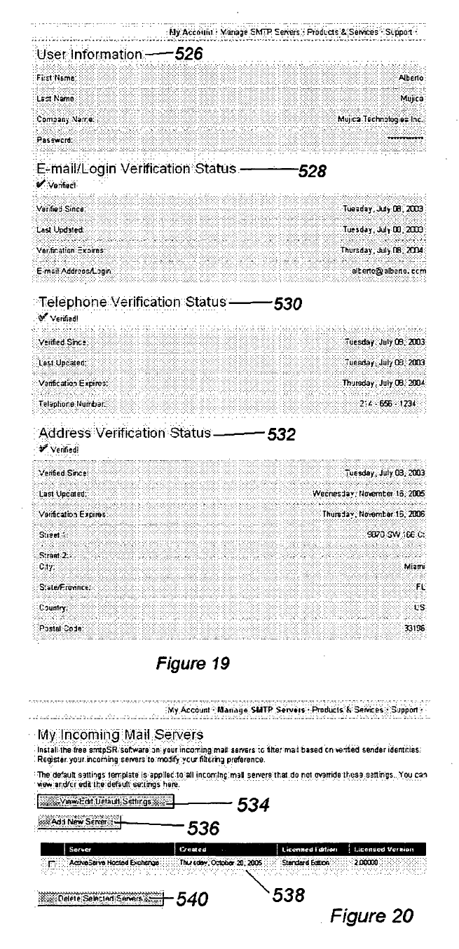

Referring to FIG. 19, an account summary screen is shown having a user information section 526 that includes the users name and e-mail address. An e-mail, login verification section 528 provides the users e-mail address, the time it was last verified and when the verification is set to expire. A telephone verification section 530 provides the users telephone number, the time it was last verified and when the verification is set to expire. Finally, an address verification section 532 provides the users telephone number, the time it was last verified and when the verification is set to expire. The account summary screen provides the user a quick view of its information and whether the information is verified or not.

A user verifies his email address by clicking on a unique link sent to the email to be verified and asking the user to then login using the credentials specified by the user during registration to ensure that the user has access to the email address and that the e-mail address actually exists. A user verifies his telephone number by requesting verification on the website. When the user requests to verify a specific phone number, the website calls the phone number provided and displays a code on the website. The user will then need to enter the code displayed on the website into the telephone using the telephone key pad to verify that the user has access to the web interface and that the user's telephone number indeed exists. And finally, a user verifies his postal address by providing a credit card in which the billing address is the address to be verified. If the address to be verified matches the address associated with the credit card, then the address is considered verified. Another way to verify the postal address for non credit card holders will be to deliver a post card with a secret code for the user to enter on the web interface thereby confirming the address and that the owner has access to the web interface.

It should be understood that verification of a user's e-mail address, telephone number and postal address are part of the information used to establish a user's reputation. Other factors that may be used to develop the user's reputation include, but are not limited to, when the user last sent a computer virus in an e-mail message, whether the user honors unsubscribe requests, credit scores, credit history, length of time in business, Dun & Bradstreet ratings, whether the user has filed for bankruptcy, etc. A user's e-mail sending patterns can also be used in establishing a user's reputation. For example, if a user sends 10,000 e-mails a month on average and suddenly increases ten fold, the user's new sending patterns may indicate that the user has begun mass advertising in the form of unsolicited spam. Thus, the user's reputation and sending patterns can be used as criteria for recipients to determine whether or not they wish to receive e-mail from the user.

Once the user sets up an account, servers can be registered with web service 14. Referring to FIG. 20, an incoming server screen is shown listing the servers registered on web service 14. A button 534 allows the user to view/edit the default settings that are applied to all incoming servers listed at 538. A button 536 allows the user to add servers to the account. Button 540 deletes all servers that are selected.

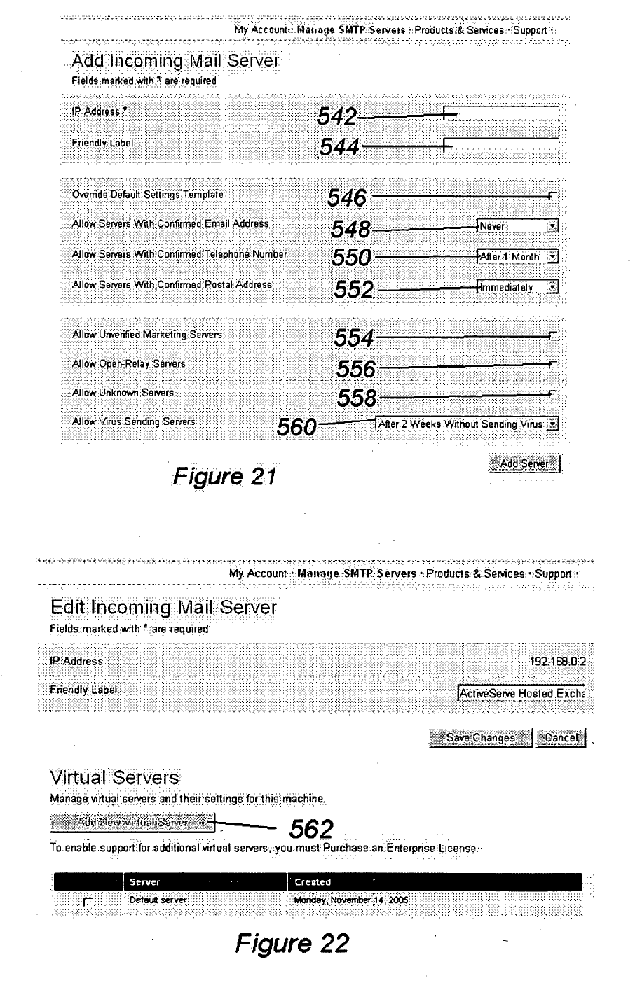

Pressing button 536 takes the user to the web interface page shown in FIG. 21. At entry line 542 the user can enter the IP address for the incoming server being added. At entry line 544, the user can enter a shortcut name for the server. If check box 546 is checked, then the users settings for the new server will override the default settings. Drop box 548, 550, and 552 allow the user to set the parameters for mail coming from servers. In particular, drop box 548 allows the user to set the time parameters for e-mails that are confirmed. The user may choose between “never,” “after a predetermined period” (i.e. 1 month) and immediately. The same can be set for a confirmed telephone number 550 and a confirmed address 552. Several check boxes 554, 556 and 558 allows the user to select if they want to receive e-mail from unverified marketing servers, open relay servers and unknown servers, respectively. Finally, at 560, the user may select when a server that previously sent a virus can send e-mail to the listed incoming server. Thus, for example, the user may allow e-mails from unverified servers but, as soon as one of these servers sends a virus to the user, the user can choose to never receive an e-mail from the sender in the future, receive an e-mail after a predetermined time period has passed, or to continue to receive e-mails from the sender.

FIG. 22 provides a web interface page that allows the user to edit the setting for the incoming mail server. If a virtual server is to be established for than incoming mail server, then the user selects button 562, which brings the user to the web interface page shown in FIG. 25. The settings for the virtual server are similar to those described in FIG. 21.

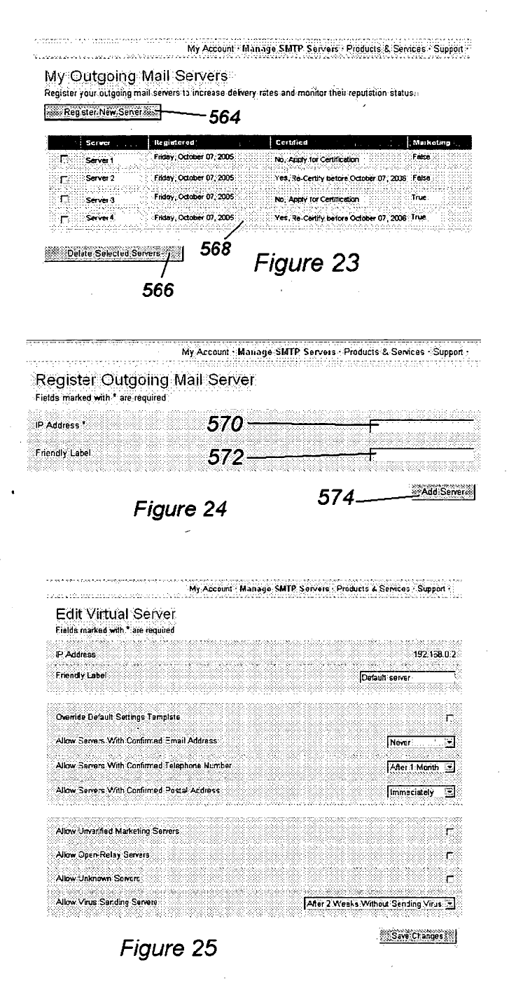

Referring to FIG. 23, the user can also register its out going mail servers. Button 564 allows the user to add new outgoing mail servers to the service, and button 566 allows the user to delete outgoing mail servers. The users outgoing mail servers are listed at 568. If a new mail server is to be added, the user selects button 564, which brings the user to the web interface page shown in FIG. 24. On this web interface page, the user can enter the IP address for the new server at entry line 570 and a shortcut name for the server at entry line 572. Once all of the information is input, the user selects an add server button 574 to add the new server to the user's account.

The system of the present invention provides for a method of tracking whether an advertiser honors unsubscribe requests. A stated above, an advertiser's response to an *unsubscribe request can affect the advertiser's reputation. Advertisers, including spammers, typically include an unsubscription link in the e-mail messages that is usually formatted as follows:

http://www.abc.com/unsubscribe.asp?Email=
xyz@def.com&CampaignID=1&SubscriptionID=2

The unsubscribe link is typically formatted in a linked image or in plain text and is usually located at the bottom of the e-mail message. The unsubscribe link allows recipients that do not want to receive additional messages from the advertiser to remove themselves from the advertiser's e-mail list. Currently though, most e-mail recipients avoid the unsubscribe link because many spammers and advertisers use the unsubscription requests only to confirm that the recipient's email addresses is valid and in use, thereby resulting in even more spam or advertising e-mails being sent to the recipient. The unsubscribe link above is broken down into several parts as described below:

```
Protocol: http:// (Only other option is https://)
Host (Also known as Domain): www.abc.com
URL: /unsubscribe.asp
Parameters: ?Email=xyz@def.com&CampaignID=
123456&SubscriptionID=09876
    Email: xyz@def.com
    CampaignID: 123456
    SubscriptionID: 09876
```

The purpose of an unsubscribe link in the MTRM system is to track advertiser's behavior by analyzing complaints after unsubscription requests have been made by the recipient. The advertiser's behavior helps to develop their reputation and sending patterns. Thus, in order for the MTRM system to use unsubscribe links to affect a senders reputation and sending patterns, a certified advertiser, through web interface 15, can create, modify, or disable an MTRM unsubscription link that is used to replace their own unsubscribe link in their messages. That is, in one embodiment, the advertiser registers it's unsubscribe links through web interface 15 and the information is stored in MTRM database 12. Web service 14 issues the advertiser a new unsubscribe link for the advertiser to include in its e-mails.

A recipient, who clicks an MTRM issued unsubscription link, has its response recorded by MTRM web service 14, which then redirects the recipient to the certified advertiser's unsubscribe link for further processing. The following is an example of a MTRM unsubscription link that is issued when the advertiser registers it's unsubscribe link with web service 14:

http://www.mujica.com/unsubscribe.asp?LinkID=
123456&EmailAddress=xyz@def.com.

An advertiser will be able to add to the end of the issued link as many additional parameters as it deems necessary, for example:

http://www.mujica.com/unsubscribe.asp?LinkID=123456&EmailAddress=
xyz@def.com&Email=xyz@def.com&CampaignID=1&SubscriptionID=2.

When a recipient clicks on the MTRM unsubscribe link the “LinkID” parameter, which is related to an advertiser's account and the advertiser's real unsibscription link, allows the MTRM system to record the unsubscription request, the email address of the recipient asking to be unsubscribed and all the other parameters related to the unsubscription. The recipient is then redirected to the original unsubscription link provided by the advertiser to complete the unsubscription request by the advertiser. All parameters (Email, CampaignID and SubscriptionID in this example) supplied beyond “LinkID” and “EmailAddress” will also be supplied to the advertiser's unsubscribe link.

For example, advertiser ABC Inc. is running a new campaign to sell cars at employee pricing. The advertiser has 3 subscriptions to which his subscribers subscribe to: (1) a weekly price list, (2) a weekly newsletter, and (3) a monthly promotions list. A user, xyz@def.com, has subscribed to the advertiser's weekly newsletter. But the user did so a long time ago and has since lost interest in the advertiser's newsletter because he has previously purchased a new car and is very happy with it. The user has not unsubscribed from the newsletter for fear of having his email confirmed and used for even more e-mail advertisements. But nonetheless the user has complained several times, anonymously, to SpamCop or other similar companies. Previous newsletters had shown the advertiser's unsubscription link as being

http://www.abc.com/unsubscribe.asp?Email=
xyz@def.com&CampaignID=1&SubscriptionID=2

but under the MTRM system, the user is presented with a new unsubscription link, as follows,

http://www.mujica.com/unsubscribe.asp?LinkID=123456&EmailAddress=
xyz@def.com&Email=xyz@def.com&CampaignID=1&SubscriptionID=2

and a caption stating “Unsubscription requests monitored by MTRM.” Under the MTRM system, the user is assured that the unsubscription request will be honored and the advertiser will not use the user's e-mail address for additional unsolicited messages. When the user clicks on the new unsubscribe link, the advertiser has 3 options:
(1) unsubscribe the user,
(2) ignore the user's request (Due to a failure in the request or negligence on the advertiser's part), or worst of all,
(3) confirm the users address and therefore increase the volume of email sent to the user.
   Depending on the advertiser's response to each of the three options above, the advertiser's action can result in three respective outcomes:
(1) Nothing will happen, no other emails will be sent from this advertiser to this recipient, and therefore, no other complaints or unsubscriptions will occur;
(2) The user will complain, the problem is settled between the advertiser and the recipient, the advertiser gets fined; or
(3) The advertiser gets de-certified for not complying with unsubscriptions requests and will therefore be blocked on sending future emails to recipients.

Operation of the MTRM System

Referring to FIG. 13, a process flow chart is shown that represents the operation of MTRM client software 10, database 12, web service 14 and web interface 15. Across the top of the figure is each component of the system, including the sender and recipient. Along the side of the flow diagram is a recipient process 400a, a message identification process 400b and a sender process 400c. In each of the three processes, certain of the same process steps are repeated for ease of presentation and explanation. It should be understood that unless a reference number is repeated on steps, then each step represents a separate distinct process step

During operation, steps in recipient process 400a, message identification process 400b and sender process 400c may occur in any order. For example, the recipient may receive a message from an unregistered sender. Once the message identification processes determines if the message should be delivered or denied, the message identification process notifies the sender to register. After which, the sender process operates when the sender establishes an account. In the alternative, the sender may establish an account first. Then once a message is sent, the recipient process is invoked and the message identification process determines whether to accept or deny a message. Thus, the following explanation is presented as an example on one embodiment of the process, and one of ordinary skill in the art should understand that there are an many other orders of process flow that may be carried out by the present system.

Recipient process 400a begins by recipient 218 (or their ISP, corporate IT or other e-mail server administrator) creating an account at step 402 with MTRM web service 14. The recipient performs this function through the web interface page shown in FIGS. 17 and 18. The recipient inputs the necessary criteria to MTRM web service 14 at step 404 that is used in determining which e-mails should be accepted for the recipient or denied. MTRM web service 14 stores the recipient criteria at step 406 in MTRM database 12. Once an account is registered, the recipient may download and install MTRM client software 10 at step 408. The recipient then configures MTRM client software 10 at step 410 through the web interface page show in FIG. 21.

MTRM client software 10 allows recipients to report spam or complain about a sender's behavior using MTRM reporter 15 at step 412, and the information is used to develop the sender's patterns at step 458 and a reputation at step 460. If a sender is registered, the recipient may choose to unsubscribe from a sender's e-mail list at step 412 by clicking on the MTRM unsubscribe link found in the sender's message. This action causes web service 14 to store information about the sender, the recipient and the message in MTRM database 12. The MTRM unsubscribe link then forwards the recipient to a location specified by the sender's unsubscribe link that was previously registered with web service 14 and associated with the MTRM unsubscribe link. Web service 14 uses the information gathered from the unsubscribe link to develop the sender's sending patterns at step 460 and the information is stored in MTRM database 12. When the MTRM unsubscribe link is clicked, the sender should unsubscribe the recipient from its e-mail list at step 452 and stop sending e-mail messages at step 454.

Message identification process 400b operates when either an unregistered or registered sender attempts to send a message to one or more recipients. At step 448, 448a and 448b messages are sent from the sender and received by MTRM client software 10 at step 416, where the sender's information is sent at step 418 to MTRM web service 14. At step 420, MTRM client software 10 is authenticated based on information in MTRM database 12. At step 422, the recipients' stored criterion is extracted from MTRM database 12, and at step 424, MTRM web service 14 extracts the sender's reputation information from MTRM database 12. At step 426, the sender and recipient information is compared and a decision to accept or deny the message is made by MTRM web service 14. At step 428, the decision is sent by the MTRM web service to MTRM client software 10.

Once a decision on whether to accept or deny a message is sent to MTRM client software 10, the client software either accepts or denies the message at step 430. If the message is accepted, client software 10 determines if the message is from a billable advertiser at step 432, and if accepted, and the message is from a billable advertiser, the sender is billed at step 434 through MTRM web service 14. The decision to bill a sender for a delivered message is determined by MTRM client software 10 at step 432. While the billing decision can also be made by web service 14, it is better made by client software 10 because of caching, but nonetheless, other embodiments of the invention may make the decision to bill advertisers at the web service or other central location.

More specifically, depending on the cache setting set by the user in the “smtpRM” tab of the MTRM client (FIG. 8), a sender's information is initially checked by web service 14. Once the original decision to accept or deny a message is sent from web service 14 to MTRM client software 10, the data is stored in cache, which is used to check new incoming messages sent from the same sender. If another message from the sender is received before the cache is cleared, MTRM client software 10 compares the information from the new message with the information stored in cache and notifies the MTRM web service at step 432 of the transaction so the sender can be billed if the e-mail is an advertisement. The use of cache reduces the amount of traffic between a recipient's computer and web service 14, which speeds up the MTRM system performance. If the recipient decides to use minimum cache, then more information must be transmitted between the recipient's server and the MTRM web service in making a decision whether to accept or deny a message.

If the message is denied at step 430, the message may be stored, logged or deleted at step 436. If it is stored, the message can be optionally tagged and delivered at step 440 and sender 204 can be notified by a message, at step 442, that the message was delivered but will be denied in the future unless the sender registers with the MTRM system. If the sender receives a message at step 442, the sender may create an account at step 444 by registering with MTRM web service 14 via web interface 15, as described above with reference to FIG. 18.

During registration, at step 446, the sender's information is verified and stored in MTRM database 12. Once registered, the user may send messages to recipients. Whether a sender is registered or not, a sender can generally send three types of e-mail messages: advertisements, non-advertisement messages and spam.

If a non-advertisement message is sent at step 448, the message enters message identification process at step 416. If the sender is registered, then message identification process 400b carries out the steps described above. If the sender is unregistered delivery of the message is governed by the recipient's settings in MTRM client software 10 and criteria set through web interface 14. The message is then delivered or denied in accordance with the recipients settings. A user may lodge a complaint if the non-advertisement e-mail was unwanted at step 412. The complaint can be logged and stored for future use and can affect the sender's reputation. Thus, complaints can hinder the delivery of future e-mails to both the recipient lodging the complaint and future recipients.

If an advertisement message is sent at step 448a, the recipient may provide feedback at step 412 to MTRM web service 14 using MTRM reporter 15, if the message was unsolicited or unwanted. Feedback is used at step 458 to affect sender patterns and in turn the sender's reputation, at step 460. If a recipient lodges a complaint about a sender, the sender may be billed, at step 472, if the feedback is a complaint and after an investigation of the complaint is conducted to verify the veracity of the complaint. Complaints about unregistered senders can be stored and used to affect the sender's reputation should the sender eventually register with the MTRM system.

If a virus is sent at step 468, the message is scanned at 456 and denied. Finally, if spam is sent at step 448b, recipients may provide feed back at step 412 complaining that the sender sent spam, and future messages from the sender may be denied at step 456. If the sender of spam is registered, then the recipient may request to be unsubscribed from the sender's e-mail list by clicking on the unsubscribe link included in the message. As described above, the unsubscribe link allows the MTRM system to track unsubscribe requests and the information may be used to affect the sender's reputation. The sender may be notified at step 470 that the message was denied for a variety of reasons, for example the message contained a virus, the sender was unregistered, etc.

MTRM web service 14 determines the sender's sending patterns at step 458 and the sender's reputation at step 460 based on the sender's sending patterns. The sender's reputation is stored by web service 14 in MTRM database 12 and is used in the future at step 424 to decide whether to accept or deny future e-mail messages during the message identification process. That is, sending patterns can be used to determine if e-mail sent from a sender is fraudulent, especially if the e-mail being sent is contrary to the sender's previously established patterns. The sender's reputation can also be used to determine if messages should be accepted or denied. That is, the recipient can set parameters at step 404 for accepting messages based on the sender's reputation.

The MTRM system allows a recipient to determine what e-mails should be accepted or denied based on criteria set by the recipient and by e-mail patterns established by the sender's previous behavior. The MTRM system also allows the recipient to complain when unwanted messages are received, and the complaints can affect the sender's ability to have future e-mails delivered to recipients. Moreover, the MTRM system can track a recipient's request to be unsubscribed from sender's e-mail lists. Moreover, the sender's response to unsubscribe requests can affect its reputation and its ability to have future e-mail messages delivered to recipients. From the above description, one of skill in the art should recognize the versatility of the MTRM system and its ability to manage the delivery of messages between senders and recipients.

The present invention has been described in the context of an e-mail delivery system over the internet. The system may also be used in other communication systems such as a voice over IP system (VoIP) environment, a landline or cellular telephone system, instant messaging systems, etc.

For example, in a VoIP system, calls are routed over the internet similar to data. Thus, information about the caller and the recipient can be embedded in the packets of information. Recipients and callers can establish an account with MTRM web service 14 though web interface 15. When a caller makes a call to a recipient, digital data such as the caller's number, caller identification information etc. can be stripped from the packets of information and used to determine if the caller is an advertiser, and whether the call should be connected to the recipient or denied based on information provided by the recipient. Thus, similar to the e-mail system described above, mass marketers can be screened and billed for calls that are connected to recipients.

It should be understood that the present invention can also be adopted to work in a standard landline or cellular telephone system. For example, most telephone systems route calls based on the telephone number called. Imbedded in the call information can be caller information and recipient information that allows the present invention to track a caller, establish calling patterns, associate the callers reputation with the caller, review the caller information and compare the information to parameters setup by recipients. Based on the caller information, reputation and calling patterns and the recipient information, calls can be accepted and connected or denied. Marketers can be charged for each call that is connected based on the recipient's predetermined information and mass marketers can be blocked.

The key to applying the system of the present invention to VoIP, landline and cellular systems is having a unique identifier that identifies the caller. An example of such an identifier is the caller's phone number. However, it should be understood that other such identifiers can be used such as an electronic serial number (ESN) for cellular phones. The key aspect of an identifier is for the identifier to be difficult, or impossible to forge. Thus, senders or callers can be accurately identified and billed for calls or messages that are completed and reach a recipient.

The use of the present invention is also contemplated in all types of communication systems where the communication data contains information about the sender and receiver that can be used to determine if the sender wishes to receive or deny the communication. If the communication is a marketer that the recipient wishes to receive communications from, the present invention is designed to allow such communication and charge the marketer a fee for allowing the communication to be completed.

It should also be understood that the present invention can also be used in HTTP browsing and instant messaging systems since these systems are based on a host name, IP address and a port number that is unique for each web site. Thus, as with the e-mail system described above, as a user browses web pages, those that do not meet the user's preset parameters are blocked and those that do can be browsed and the web page owner may be billed each time a user visits the page. With regard to instant messaging, senders can be tracked by their usernames since each username is unique and provides an identifier to track the sender and recipient.

The embodiments depicted are presented by way of example only and are not intended as limitations upon the present invention. Thus, it should be understood by those of ordinary skill in this art that the present invention is not limited to these embodiments since modifications can be made. Therefore it is contemplated that any and all such embodiments are included in the present invention as may fall within the literal and equivalent scope of the appended claims.

What is claimed is:

1. A method for filtering communications comprising:
a. receiving a communication from a sender;
b. extracting unique identification information from the communication that identifies the sender of the communication;
c. extracting a first set of information stored in a database that is associated with the unique identification information;
d. extracting a second set of information that is stored in the database that is associated with a recipient's preferences about the types of communications the recipient is willing to receive;
e. comparing the first set of information with the second set of information to determine if the communication should be allowed or denied;
f. allowing the communication to reach its intended recipient or denying the delivery of the communication based on the result of the comparison of the first set of information with the second set of information;
g. billing the sender for each delivery of the communication.

2. The method of claim 1, wherein the first set of information includes data regarding previously sent communications.

3. The method of claim 1, wherein the first set of information includes one or more of the senders name, address and telephone number.

4. The method of claim 1, wherein the database is located remote from the sender and the recipient.

5. The method of claim 1, further comprising sending a notice to the sender when the communication is denied.

6. The method of claim 1, further comprising denying the delivery of the communication if the first set of information is not available for the sender.

7. The method of claim 5, wherein the notice invites the sender to register with a service so that future communications can be delivered to recipients.

8. The method of claim 1, wherein the communication is an e-mail communication.

9. The method of claim 8, wherein the unique identifier is a server address for the sender.

10. A method for filtering e-mail communications comprising:
a. receiving an e-mail communication from a sender;
b. extracting at least one unique identification information from the e-mail communication that identifies the sender of the e-mail communication;
c. extracting a first set of information stored in a database that is associated with the at least one unique identification information;
d. extracting a second set of information that is stored in the database that is associated with a recipient's preferences about the types of e-communications the recipient is willing to receive;
e. comparing the first set of information with the second set of information to determine if the e-mail communication should be allowed or denied;
f. allowing the e-mail communication to reach its intended recipient or denying the delivery of the e-mail communication based on the result of the comparison of the first set of information with the second set of information;
g. billing the sender for each delivery of the e-mail communication.

11. The method of claim 10, wherein the at least one unique identification information is the sender's mail server IP address.

12. The method of claim 10, wherein the first set of information includes one or more of when the sender last verified it's e-mail address, when the sender last verified it's mailing address, when the sender last verified it's telephone number, the last time the sender sent an e-mail communication containing a virus and what type of e-mail sending patterns the sender has developed.
